(19) United States
(12) Patent Application Publication
(10) Pub. No.: US 2007/0032751 A1
(43) Pub. Date: Feb. 8, 2007

(54) Filled full shell massage implement

(75) Inventor: Julia A. Roman, Ewing, NJ (US)

Correspondence Address: LAW OFFICES OF ARTHUR E. JACKSON, P.O. BOX 88, HOPEWELL, NJ, 08525, US

(73) Assignee: Sea and Land Therapies, LLC

(21) Appl. No.: 11/196,818

(22) Filed: Aug. 3, 2005

(51) Int. Cl. A61H 7/00

(52) U.S. Cl. 601/15; 601/135; 601/137; 601/DIG. 1

(57) ABSTRACT

Provided is, among other things, a massage implement comprising a paired set shells filled with a heat-retentive, inert material, sealed at the edges in a water-tight manner, and coated on outer surfaces with a polymer.

The present invention relates to implements for massage that are based on the shells of bivalve animals such as aquatic mollusks (e.g., clams, cockles, mussels, oysters, scallops, and the like).

Sea shells have been used in massage therapy. These shells were half shells, and were not, it is believed, sufficiently effective for delivering heat to the massage recipient. Moreover, it has been found that unprocessed shells can have very small, subsidiary surface structures (in addition to larger, desired ridge structures) that can provide a rasp-like feel for the massage recipient.

In a more heat retentive form, sea shells provide excellent tools for placing heated objects statically on a recipient's body, with the shell texture providing a soothing feel. Also, this kind of heat-retentive implement is easily handled for moving it across a recipient's body in a soothing, massage-appropriate manner. The texture of the implement can provide a further soothing sensation.

### SUMMARY OF THE INVENTION

The invention provides, in one embodiment, a massage implement comprising a paired set shells filled with a heat-retentive, inert material, sealed at the edges in a water-tight manner, and coated on outer surfaces with a polymer.

In another embodiment, the invention provides a method of conducting massage comprising: heating one or more massage implements to a temperature above the body temperature of the massage recipient, and moving one of the heated implements over at least a portion of the recipients body using a massage-appropriate amount of pressure and, at least during a portion of the moving, moving the implement against the grain of striations in a recipient-contacting portion of the implement. The method can further comprise, for example, placing one or more heated implements on massage-appropriate points on the recipients body and leaving the implements in place for a massage appropriate amount of time.

In another embodiment, the invention provides a method of conducting massage comprising: heating one or more massage implements to a temperature above the body temperature of the massage recipient, and placing one or more heated implements on massage-appropriate points on the recipients body and leaving the implements in place for a massage appropriate amount of time.

In still another embodiment, the invention provides a method of making a massage implement comprising: filling cavities in a paired set of shells with a heat retentive material; joining the shells together to form an summed cavity; and coating exterior surfaces of the paired shells with a transparent polymer.

### BRIEF DESCRIPTION OF THE DRAWINGS

FIG. 1 shows a side view of a bivalve shell filled with inert material

FIG. 2 illustrates a shell implement as it can be held by a masseuse.

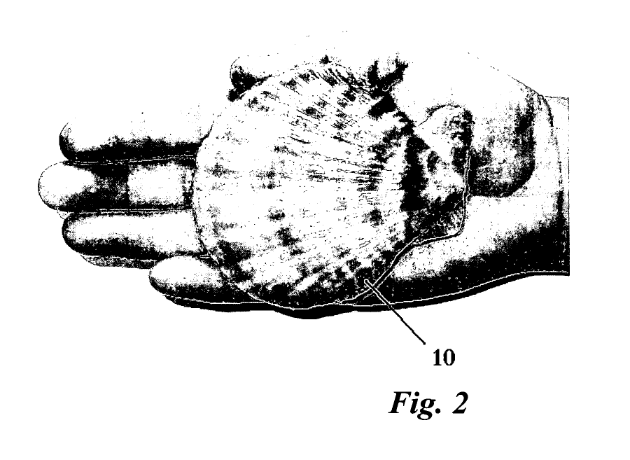

### DETAILED DESCRIPTION OF THE INVENTION

Heated shell implement(s) 10 can be heated and placed at various points of a recipient's body. Concurrently or separately a heated shell implement 10 can be held in one or both hands of a massage therapist and effleuraged and/or petrissaged at various areas of a recipient's body. Both the physical attributes of the implement, and the aesthetic attributes can aid in eliciting deep and soothing muscle relaxation.

Heat provides a useful adjuvant to massage therapy. The shell implement provides heat retention and can provide texture. Texture provides friction in the massage, which can be adjusted as described herein. The shells have a convex shape that is easily held and manipulated in massage.

Because shells generally have a systematic pattern of ridges, the degree of friction provided by the implement can be adjusted in a number of ways. For example, the orientation of the ridges to the massage movement will adjust the friction. Also, the shell implement can be selected for its ability to provide friction (higher or lower ridges, wider or narrower ridge spacing, differing pattern of ridges, or the like). Further, an amount of polymer coating on the exterior of the shell can adjust the degree of friction provided.

To construct the massage implement, one can, in one embodiment, drill a hole in one or both of a paired set of shells. The hole can be at the seam between the two shells, such as at the base B of the shell. The base can be selected as a location having good physical strength to accommodate one or both of the drilling or the removal of shell material to form the hole. The shells can be glued together before or after the drilling, to form the cavity. A heat-retentive material can then be inserted into the cavity through the hole. A material is appropriately heat retentive if the finished implement retains heat in an amount and for a period of time that allows convenient heat-assisted massage without inconveniently frequent exchanges of cooled for heated implements. The hole can be closed with glue or another material that can serve as a filler. A portion of the outer surface of the shells to be used for massage can be coated with clear polymer. This coating can be done at any stage in process, but is conveniently done after filling the cavity. The coating can provide for sealing the hole.

The heat-retentive material can be a material that gels after filling (for example, poured hot in a ungelled state or including gelling agent such as a polymer crosslinker). Or, the heat retentive material can be flowable, such as play grade sand. If flowable, then steps must be taken to stop flow out of the hole. For example, the optional hole can be filled, or a gellable material (or material that otherwise transitions from a flowable to a solid form) infused into the portion of the heat retentive material adjacent to the hole to form a plug (such as with the polymer coating material). During production, the paired shells can be inspected as needed for leakage of heat retentive material and re-filled as needed. The heat-retentive material can be inert, meaning that it is sufficiently stable against decay or spoilage to allow the massage implement to have a commercially useful lifetime.

In another embodiment, the heat retentive material can be sufficiently tacky such that when molded to the cavities defined by each shell of a pair, the material stays in place while the resulting two halves of the implement are mated (forming a summed cavity as defined below). In one embodiment, the heat retentive material is comprised of a particulate, such as for example sand, mixed with an adhesive polymer composition (which can be a polymer-forming composition). With this embodiment, the joining of the two halves of heat retentive material can provide or add to the adhesion between the two paired shells. The amount of particulate can be selected as about the largest amount that results in an appropriately pliable material for conforming to the sides of the cavities of the shells. Using sand, a useful initial ratio by volume can be 4 parts sand to 1 part polymer-forming composition. The ratio can be adjusted as needed based on the working qualities of the mixture.

In the embodiment of the previous paragraph, coating with polymer can follow joining the shell halves. The coating can serve to seal or further seal together the edges of the paired shells. In this and other embodiments, coating can be done earlier, but is conveniently done after filling the shells with heat retentive material. In this and other embodiments, two or more coating steps can be used.

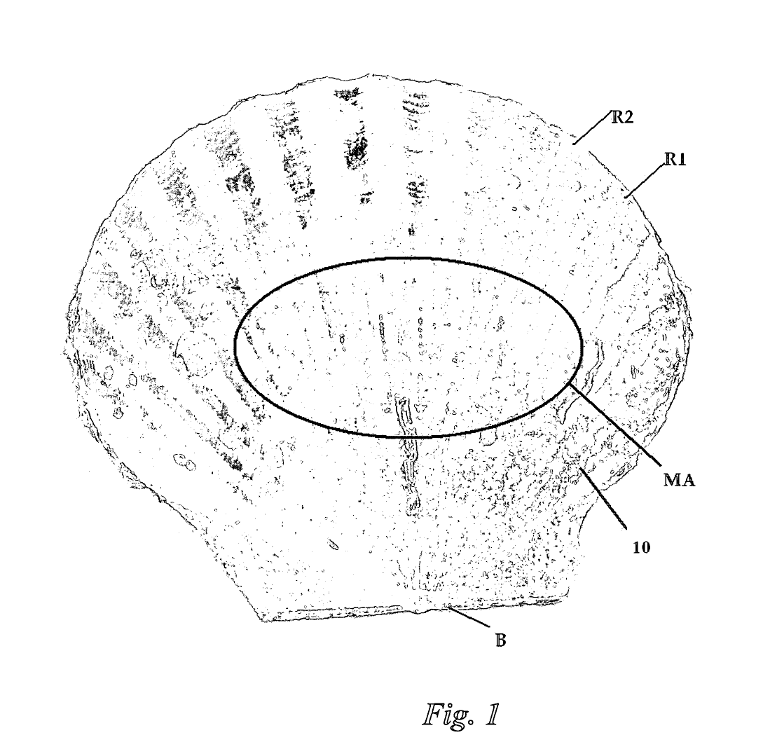

After filling and coating, rough spots from the shell or the coating can be ground down. Grinding can also remove rough spots created from leakage of particulate heat retentive material during filling. For the most part, the coating process removes fine patterns that are less comfortable to the massage recipient that the larger ridge pattern such as seen in FIG. 1 (see, ridge R1 and ridge R2).

Paired shells can be obtained, for example, from Shell Horizons, Clearwater, Fla. If shells are obtained that are already glued together, it may be useful to remove that glue. If already glued to the standard needed, the production process can skip steps designed to seal the edges of the shells.

One useful coating material is polyurethane, such as for example polyurethane sold as EvironTex Lite™ (Environmental Technology, Inc., Fields Landing, Calif.) or as Clear Resin 1000 by RBC Industries, Inc. (Warwick, R.I.) (a water-based composition). Clear Resin 1000 is usefully used with a hardener, such as Hardener AB-91 from RBC Industries, Inc. Other polymer materials will be recognized as applicable by those of skill in the coating arts. Coatings that form polymer by polymerizing monomers or smaller polymers, or crosslinking these materials, can have the advantage of increasing the softening point for the coating. Also, with solvated polymers such as EvironTex Lite™ coating, the polymer content can be adjusted to increase the softening point.

Useful temperatures for massage include temperatures from about 100° F. (37.7° C.) and higher, or about 105° F. (40.6° C.) and higher, or about 110° F. (43.3° C.). Useful temperatures can be to about 120° F. (48.9° C.) and lower, or about 115° F. (46.1° C.) and lower. These temperatures can be achieved with a warmer, such as a water-bathed warmer or a warming oven. The materials used to form the implement can be selected to be stable at temperatures of about 100° F., or 110° F., or 120° F, or 140° F., or 160° F., or 180° F., or 200° F.

Glue can be applied from a glue gun, and can be from a glue gun stick as can be found in most art supply stores.

When coated with polymer, the polymer can be effective in making the color of the shell appear much richer. Transparent polymer coatings are believed to have this effect, even when lacking a coloring agent.

Definitions

The following terms shall have, for the purposes of this application, the respective meanings set forth below.
massage recipient

Most often a massage recipient is a human, but other animals can need massage.
summed cavity

The summed cavity is approximately the union of the cavities found in each of the shells of a paired set. The summed cavity can be filled with heat retentive material (even though the “cavity” is no longer unfilled).
paired set of shells

A paired set of shells is two shells whose seams match sufficiently so that they can be glued together to form an summed cavity in which a heat retentive material can be deposited and isolated from the exterior. Generally, a paired set will be the two shells from one bivalve shell fish.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A massage implement comprising a paired set shells filled with a heat-retentive, inert material, sealed at the edges in a water-tight manner, and coated on outer surfaces with a polymer.

2. The massage implement of claim 1, wherein the polymer coating is transparent.

3. A massage kit comprising:
one or more massage implements of claim 1, and
packaging comprising instructions on the use of the implement as a heated implement in massage therapy.

4. The massage implement of claim 1, wherein the amount of outer coating polymer is effective to reduce rasping texture on the exterior surfaces, while retaining a striated texture that can be sensed by person receiving a massage using the implement.

5. The massage implement of claim 1, wherein the heat-retentive material comprises a heat retentive amount of sand.

6. The massage implement of claim 1, wherein the coating material is selected to be stable at temperatures of 120° F.

7. A method of conducting massage comprising:
heating one or more massage implements of claim 1 to a temperature above the body temperature of the massage recipient, and
moving one of the heated implements over at least a portion of the recipients body using a massage-appropriate amount of pressure and, at least during a portion of the moving, moving the implement against the grain of striations in a recipient-contacting portion of the implement.

8. The method of claim 7, further comprising:
placing one or more heated implements on massage-appropriate points on the recipients body and leaving the implements in place for a massage appropriate amount of time.

9. The method of claim 7, wherein the implements are heated to a temperature of about 100° F. (37.7° C.) to about 120° F. (48.9° C.).

10. The method of claim 7, wherein the implements are heated to a temperature of about 105° F. (40.6° C.) to about 115° F. (46.1° C.).

11. The method of claim 7, wherein the implements are heated to a temperature of about 110° F. (43.3° C.).

12. A method of conducting massage comprising:
heating one or more massage implements of claim 1 to a temperature above the body temperature of the massage recipient, and
placing one or more heated implements on massage-appropriate points on the recipients body and leaving the implements in place for a massage appropriate amount of time.

13. A method of making a massage implement comprising:
filling cavities in a paired set of shells with a heat retentive material;
joining the shells together to form an summed cavity; and
coating exterior surfaces of the paired shells with a transparent polymer.

14. The method of claim 13, wherein the cavities are filled with a cavity-conforming heat retentive material.

15. The method of claim 13, wherein the cavities are filled through a hole in the joined shells.

16. The method of claim 13, wherein the heat-retentive material comprises a heat retentive amount of sand.
